(19) United States
(12) Patent Application Publication
(10) Pub. No.: US 2020/0361189 A1
(43) Pub. Date: Nov. 19, 2020

(54) Composite Laminate Including a Thermoplastic Polyurethane Film Layer

(71) Applicant: Lubrizol Advanced Materials, Inc., Cleveland, OH (US)

(72) Inventors: Satyanarayana Nistala, Mentor, OH (US); Joseph J. Vontorcik, Jr., Broadview Hts., OH (US); Greg S. Nestlerode, Norton, OH (US); Joseph Citrano, III, Eden Prairie, MN (US)

(73) Assignee: Lubrizol Advanced Materials, Inc., Cleveland, OH (US)

(21) Appl. No.: 16/640,406

(22) PCT Filed: Aug. 22, 2018
(86) PCT No.: PCT/US2018/047511

§ 371 Date: Feb. 20, 2020

Related U.S. Application Data
(60) Provisional application No. 62/551,278, filed on Aug. 29, 2017.
(60) Provisional application No. 62/557,335, filed on Sep. 12, 2017.

(51) Int. Cl. B32B 27/12; C08G 18/42; C08G 18/44; C08G 18/60; C08G 18/61; C08G 18/76; C08G 18/73; C08L 75/12; B32B 5/28; B32B 27/40; C08J 5/24; B32B 5/02; B32B 5/12

(52) U.S. Cl. CPC B32B 27/12; C08J 2363/00; C08G 18/44; C08G 18/603; C08G 18/61; C08G 18/7671; C08G 18/73; C08L 75/12; B32B 5/28; B32B 27/40; C08J 5/24; B32B 5/024; B32B 5/12; C08L 2203/16; B32B 2260/021; B32B 2260/046; B32B 2262/106; B32B 2307/536; B32B 2307/732; B32B 2305/076; C08G 18/4277

(57) ABSTRACT

A composite laminate structure includes one or more layers of prepreg and a thermoplastic polyurethane film layer on the surface of the one or more prepregs. A method of making a composite laminate structure including a thermoplastic polyurethane film is also provided.

### TECHNICAL FIELD

The present invention relates to composite laminates including a thermoplastic polyurethane film layer and methods for making such articles. The articles comprise one or more layers of fiber containing prepreg having a thermoplastic polyurethane film bonded to the surface. The structure and method of the present invention eliminate the need for the application of coatings to the prepreg in order to impart properties such as color, UV resistance, abrasion resistance and the like.

### BACKGROUND

Composite laminate structures are made from stacked sheets of prepregs. The laminate structures are typically coated on an outer surface with one more coating layers in order to provide certain properties such as resistance to water, solvents, or UV light, weather, abrasion, and/or corrosion. The coatings may also provide decoration to the laminate depending on the application. The preparation for and application of coatings to the composite laminate structures can be a time consuming and costly process. In addition, in some cases the coatings lack durability and must be reapplied periodically or the laminate must be replaced.

Thus, there exists a need to provide a durable composite laminate structure and a method of making a composite laminate structure that has desirable and beneficial properties.

### SUMMARY OF THE INVENTION

The present invention provides a composite laminate having improved surface properties and a method of making the composite laminate. The composite laminate comprises one or more fiber containing prepreg layers and a thermoplastic polyurethane film layer. A prepreg layer comprises a fibrous substrate such which has been impregnated with a resin (either a thermoplastic or a thermoset resin). The prepreg layers may include unidirectional fibers, woven fibers, or non-woven fabrics or a combination thereof. A thermoplastic film layer is adhered to an outer surface of the prepreg layers. No additional binder material, other than the prepreg resin and the thermoplastic polyurethane layer, is required in the present invention.

### BRIEF DESCRIPTION OF THE DRAWINGS

FIG. 1 illustrates a prior art process to make a composite laminate structure.

FIG. 2 illustrates a process to make a composite laminate structure in accordance with one embodiment of the present invention.

FIG. 3 illustrates a second prior art process to make a composite laminate structure.

FIG. 4 illustrates a process to make a composite laminate structure in accordance with another embodiment of the present invention

### DETAILED DESCRIPTION OF THE INVENTION

The present invention comprises a composite laminate structure made up of one or more fiber containing prepreg layers and a thermoplastic polyurethane film layer. Each of the layers of the composite laminate structure and the method for making the composite laminate structure are described in more detail below.

### Fiber Containing Prepregs

As used herein, the term “prepreg” refers to a sheet of fibers impregnated with resin. The prepregs include fibrous substrates, which may be selected from unidirectional fibers, fabrics made from woven fibers, or non-woven fabrics. The material for the fiber (or filaments that make up the fiber) may be selected from any materials known to those skilled in the art including but not limited to carbon, graphite fibers, glass, minerals, or even polymers, such as fibers made from polyolefin, polyethylene, polypropylene, aramid, polybenzazole, polyurethane, polyvinyl alcohol, polyacrylonitrile, liquid crystal copolyesters, polyamides, polyesters, or combinations thereof.

To form a sheet of prepreg, continuous fibers formed of individual or bundles of filaments of the selected materials may be oriented linearly to form a sheet of unidirectional fibers, or the filaments or fibers may be woven to form a woven sheet as is known to those of ordinary skill in the art. The fibrous sheets are then impregnated with resin to form the sheets of prepreg. The resins used to form the prepreg may include any resins known to those skilled in the art, for example, epoxy resins, phenolic resins, bismalemide, polyamide, cyanate ester, polycarbonate, polyester, polystyrene, polyether, acrylonitrile, butadiene, acrylate, methacrylate, polyacetal, polysulfone, polyurethane, thermoplastic polyurethanes, and mixtures thereof. Useful resins may be thermoset or thermoplastic or a combination thereof. Methods for impregnating the fibrous sheets with resin are well known in the art. In one embodiment, the resin used in the prepreg comprises an epoxy resin, for example, a thermoset epoxy resin.

In one embodiment, the prepreg used in the composite laminate of the present invention comprises carbon fibers. In another embodiment, the prepreg layer of the composite laminate contains fibers which consist of carbon fibers. The carbon fibers in this embodiment may be impregnated with an epoxy resin. In one embodiment, the carbon fibers are impregnated with a thermoset epoxy resin.

Various types of prepregs are commercially available from companies such as Cytec and Zoltek (Toray), and are sold as LTM® prepregs, MTM® prepregs, HTM® prepregs, VTM® prepregs, CYCOM® prepregs, DForm® technology, BPS—Body Panel Systems prepregs, and CYFORM® prepregs.

### Thermoplastic Polyurethane Film

The composite laminate of the present invention includes a thermoplastic polyurethane film layer. Thermoplastic polyurethanes (TPU) are obtained by the reaction of a polyisocyanate, a polyol intermediate, and, optionally, a chain extender component. In this reaction, a catalyst is used if needed.

Any polyisocyanates known to those skilled in the art may be used to make TPU compositions useful in the present invention. In some embodiments, the polyisocyanate component includes one or more diisocyanates, which may be selected from aromatic diisocynates or aliphatic diisocyanates or combinations thereof. Examples of useful polyisocyanates include, but are not limited to aromatic diisocyanates such as 4,4′-methylenebis(phenyl isocyanate) (MDI), m-xylene diisocyanate (XDI), phenylene-1,4-diisocyanate, 3,3′-dimethyl-4,4′-biphenylene diisocyanate (TODI), 1,5-naphthalene diisocyanate (NDI), and toluene diisocyanate (TDI), as well as aliphatic diisocyanates such as isophorone diisocyanate (IPDI), 1,6-hexamethylene diisocyanate (HDI), 1,4-cyclohexyl diisocyanate (CHDI), decane-1,10-diisocyanate, lysine diisocyanate (LDI), 1,4-butane diisocyanate (BDI), pentamethylene diisocyanate (PDI), and dicyclohexylmethane-4,4′-diisocyanate (H12MDI). Mixtures of two or more polyisocyanates may be used.

Isocyanates used to make the TPU films useful in the present invention will depend on the desired properties of the final composite laminate structure as will be appreciated by those skilled in the art.

The TPU compositions useful in the present invention are also made using a polyol intermediate component. Polyol intermediates include polyether polyols, polyester polyols, polycarbonate polyols, polysiloxane polyols, and combinations thereof.

Suitable hydroxyl terminated polyester intermediates include linear polyesters having a number average molecular weight (Mn) of from about 300 to about 10,000, from about 400 to about 5,000, or from about 500 to about 4,000. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

In some embodiments, dimer fatty acids may be used to prepare polyester polyols that may be used in making the TPU compositions useful in the present invention. Examples of dimer fatty acids that may be used to prepare polyester polyols include Priplast™ polyester glycols/polyols commercially available from Croda and Radia® polyester glycols commercially available from Oleon.

The polyol component may also comprise one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2202A, a 2,000 number average molecular weight (Mn) linear polyester diol, and CAPA™ 2302A, a 3,000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 300 to 10,000, or from 400 to 5,000, or from 400 to 4,000, or even 1,000 to 4,000.

Hydroxyl terminated polyether intermediates useful in making the TPU composition of the present invention include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Commercially available polyether polyols include poly(ethylene glycol) comprising ethylene oxide reacted with ethylene glycol, poly(propylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and PolyTHF® R, a random copolymer. The various polyether intermediates generally have a number average molecular weight (Mn) as determined by assay of the terminal functional groups which is an average molecular weight greater than about 500, such as from about 500 to about 10,000, from about 500 to about 5,000, or from about 700 to about 3000. In some embodiments, the polyether intermediate includes a blend of two or more different molecular weight polyethers, such as a blend of 2,000 Mn and 1,000 Mn PTMEG.

Hydroxyl terminated polycarbonates useful in preparing TPU compositions of the present invention include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Polysiloxane polyols that may be used in the TPU composition of the present invention include α-ω-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, or from 400 to 3,000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

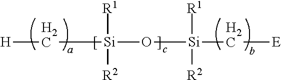

in which: each R1 and R2 are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each independently an integer from 2 to 8; c is an integer from 3 to 50. In amino-containing polysiloxanes, at least one of the E groups is NHR³. In the hydroxyl-containing polysiloxanes, at least one of the E groups is OH. In some embodiments, both R¹ and R² are methyl groups.

Suitable examples include α,ω-hydroxypropyl terminated poly(dimethysiloxane) and α,ω-amino propyl terminated poly(dimethysiloxane), both of which are commercially available materials. Further examples include copolymers of the poly(dimethysiloxane) materials with a poly(alkylene oxide).

In some embodiments, the polyol intermediate may also comprise telechelic polyamide polyols. Suitable polyamide oligomers, including telechelic polyamide polyols, are not overly limited and include low molecular weight polyamide oligomers and telechelic polyamides (including copolymers) that include N-alkylated amide groups in the backbone structure. Telechelic polymers are macromolecules that contain two reactive end groups. Amine terminated polyamide oligomers can be useful as polyols in the disclosed technology. The term polyamide oligomer refers to an oligomer with two or more amide linkages, or sometimes the amount of amide linkages will be specified. A subset of polyamide oligomers are telechelic polyamides. Telechelic polyamides are polyamide oligomers with high percentages, or specified percentages, of two functional groups of a single chemical type, e.g. two terminal amine groups (meaning either primary, secondary, or mixtures), two terminal carboxyl groups, two terminal hydroxyl groups (again meaning primary, secondary, or mixtures), or two terminal isocyanate groups (meaning aliphatic, aromatic, or mixtures). Ranges for the percent difunctional that can meet the definition of telechelic include at least 70, 80, 90 or 95 mole % of the oligomers being difunctional as opposed to higher or lower functionality. Reactive amine terminated telechelic polyamides are telechelic polyamide oligomers where the terminal groups are both amine types, either primary or secondary and mixtures thereof, i.e. excluding tertiary amine groups.

In one embodiment, the telechelic oligomer or telechelic polyamide will have a viscosity measured by a Brookfield circular disc viscometer with the circular disc spinning at 5 rpm of less than 100,000 cps at a temperature of 70° C., less than 15,000 or 10,000 cps at 70° C., less than 100,000 cps at 60 or 50° C., less than 15,000 or 10,000 cps at 60° C.; or less that 15,000 or 10,000 cps at 50° C. These viscosities are those of neat telechelic prepolymers or polyamide oligomers without solvent or plasticizers. In some embodiments, the telechelic polyamide can be diluted with solvent to achieve viscosities in these ranges.

In some embodiments, the polyamide oligomer is a species below 20,000 g/mole molecular weight, e.g. often below 10,000; 5,000; 2,500; or 2,000 g/mole, that has two or more amide linkages per oligomer. The telechelic polyamide has molecular weight preferences identical to the polyamide oligomer. Multiple polyamide oligomers or telechelic polyamides can be linked with condensation reactions to form polymers, generally above 100,000 g/mole.

Generally amide linkages are formed from the reaction of a carboxylic acid group with an amine group or the ring opening polymerization of a lactam, e.g. where an amide linkage in a ring structure is converted to an amide linkage in a polymer. In one embodiment a large portion of the amine groups of the monomers are secondary amine groups or the nitrogen of the lactam is a tertiary amide group. Secondary amine groups form tertiary amide groups when the amine group reacts with carboxylic acid to form an amide. For the purposes of this disclosure the carbonyl group of an amide, e.g. as in a lactam, will be considered as derived from a carboxylic acid group. The amide linkage of a lactam is formed from the reaction of carboxylic group of an aminocarboxylic acid with the amine group of the same aminocarboxylic acid. In one embodiment, we want less than 20, 10 or 5 mole percent of the monomers used in making the polyamide to have functionality in polymerization of amide linkages of 3 or more.

The polyamide oligomers and telechelic polyamides of this disclosure can contain small amounts of ester linkages, ether linkages, urethane linkages, urea linkages, etc. if the additional monomers used to form these linkages are useful to the intended use of the polymers.

As earlier indicated, many amide forming monomers create on average one amide linkage per repeat unit. These include diacids and diamines when reacted with each other, aminocarboxylic acids, and lactams. These monomers, when reacted with other monomers in the same group, also create amide linkages at both ends of the repeat units formed. Thus we will use both percentages of amide linkages and mole percent and weight percentages of repeat units from amide forming monomers. Amide forming monomers will be used to refer to monomers that form on average one amide linkage per repeat unit in normal amide forming condensation linking reactions.

In one embodiment, at least 10 mole percent, or at least 25, 45 or 50, and or even at least 60, 70, 80, 90, or 95 mole % of the total number of the heteroatom containing linkages connecting hydrocarbon type linkages are characterized as being amide linkages. Heteroatom linkages are linkages such as amide, ester, urethane, urea, ether linkages where a heteroatom connects two portions of an oligomer or polymer that are generally characterized as hydrocarbons (or having carbon to carbon bonds, such as hydrocarbon linkages). As the amount of amide linkages in the polyamide increases, the amount of repeat units from amide forming monomers in the polyamide increases. In one embodiment, at least 25 wt. %, or at least 30, 40, 50, or even at least 60, 70, 80, 90, or 95 wt. % of the polyamide oligomer or telechelic polyamide is repeat units from amide forming monomers, also identified as monomers that form amide linkages at both ends of the repeat unit. Such monomers include lactams, aminocarboxylic acids, dicarboxylic acid and diamines. In one embodiment, at least 50, 65, 75, 76, 80, 90, or 95 mole percent of the amide linkages in the polyamide oligomer or telechelic polyamine are tertiary amide linkages.

The percent of tertiary amide linkages of the total number of amide linkages was calculated with the following equation:

$$Tertiary amide linkage \% = \frac{{\sum }_{i = 1}^{n} ( {w}_{tertN , i} \times {n}_{i} )}{{\sum }_{i = 1}^{n} ( {w}_{totalN , i} \times {n}_{i} ) )} \times 100$$

where: n is the number of monomers; the index i refers to a certain monomer; w_{tertN} is the average number nitrogen atoms in a monomer that form or are part of tertiary amide linkages in the polymerizations, (note: end-group forming amines do not form amide groups during the polymerizations and their amounts are excluded from w_{tertN}); w_{totalN} is the average number nitrogen atoms in a monomer that form or are part of tertiary amide linkages in the polymerizations (note: the end-group forming amines do not form amide groups during the polymerizations and their amounts are excluded from w_{totalN}); and nᵢ is the number of moles of the monomer with the index i.

The percent of amide linkages of the total number of all heteroatom containing linkages (connecting hydrocarbon linkages) was calculated by the following equation:

$$Amide linkage \% = \frac{{\sum }_{i = 1}^{n} ( {w}_{totalN , i} \times {n}_{i} )}{{\sum }_{i = 1}^{n} ( {w}_{totalS , i} \times {n}_{i} )} \times 100$$

where: w_{totalS} is the sum of the average number of heteroatom containing linkages (connecting hydrocarbon linkages) in a monomer and the number of heteroatom containing linkages (connecting hydrocarbon linkages) forming from that monomer by the reaction with a carboxylic acid bearing monomer during the polyamide polymerizations; and all other variables are as defined above. The term “hydrocarbon linkages” as used herein are just the hydrocarbon portion of each repeat unit formed from continuous carbon to carbon bonds (i.e. without heteroatoms such as nitrogen or oxygen) in a repeat unit. This hydrocarbon portion would be the ethylene or propylene portion of ethylene oxide or propylene oxide; the undecyl group of dodecyllactam, the ethylene group of ethylenediamine, and the (CH₂)₄ (or butylene) group of adipic acid.

In some embodiments, the amide or tertiary amide forming monomers include dicarboxylic acids, diamines, aminocarboxylic acids and lactams. Suitable dicarboxylic acids are where the alkylene portion of the dicarboxylic acid is a cyclic, linear, or branched (optionally including aromatic groups) alkylene of 2 to 36 carbon atoms, optionally including up to 1 heteroatom per 3 or 10 carbon atoms of the diacid, more preferably from 4 to 36 carbon atoms (the diacid would include 2 more carbon atoms than the alkylene portion). These include dimer fatty acids, hydrogenated dimer acid, sebacic acid, etc.

Suitable diamines include those with up to 60 carbon atoms, optionally including one heteroatom (besides the two nitrogen atoms) for each 3 or 10 carbon atoms of the diamine and optionally including a variety of cyclic, aromatic or heterocyclic groups providing that one or both of the amine groups are secondary amines.

Such diamines include Ethacure™ 90 from Albermarle (supposedly a N,N′-bis(1,2,2-trimethylpropyl)-1,6-hexanediamine); Clearlink™ 1000 from Dorf Ketal, or Jefflink™ 754 from Huntsman; N-methylaminoethanol; dihydroxy terminated, hydroxyl and amine terminated or diamine terminated poly(alkyleneoxide) where the alkylene has from 2 to 4 carbon atoms and having molecular weights from about 40 or 100 to 2,000; N,N′-diisopropyl-1,6-hexanediamine; N,N′-di(sec-butyl) phenylenediamine; piperazine; homopiperazine; and methyl-piperazine.

Suitable lactams include straight chain or branched alkylene segments therein of 4 to 12 carbon atoms such that the ring structure without substituents on the nitrogen of the lactam has 5 to 13 carbon atoms total (when one includes the carbonyl) and the substituent on the nitrogen of the lactam (if the lactam is a tertiary amide) is an alkyl group of from 1 to 8 carbon atoms and more desirably an alkyl group of 1 to 4 carbon atoms. Dodecyl lactam, alkyl substituted dodecyl lactam, caprolactam, alkyl substituted caprolactam, and other lactams with larger alkylene groups are preferred lactams as they provide repeat units with lower Tg values. Aminocarboxylic acids have the same number of carbon atoms as the lactams. In some embodiments, the number of carbon atoms in the linear or branched alkylene group between the amine and carboxylic acid group of the aminocarboxylic acid is from 4 to 12 and the substituent on the nitrogen of the amine group (if it is a secondary amine group) is an alkyl group with from 1 to 8 carbon atoms, or from 1 or 2 to 4 carbon atoms.

In one embodiment, desirably at least 50 wt. %, or at least 60, 70, 80 or 90 wt. % of said polyamide oligomer or telechelic polyamide comprise repeat units from diacids and diamines of the structure of the repeat unit being:

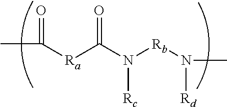

wherein: Rₐ is the alkylene portion of the dicarboxylic acid and is a cyclic, linear, or branched (optionally including aromatic groups) alkylene of 2 to 36 carbon atoms, optionally including up to 1 heteroatom per 3 or 10 carbon atoms of the diacid, more preferably from 4 to 36 carbon atoms (the diacid would include 2 more carbon atoms than the alkylene portion); and R_{b} is a direct bond or a linear or branched (optionally being or including cyclic, heterocyclic, or aromatic portion(s)) alkylene group (optionally containing up to 1 or 3 heteroatoms per 10 carbon atoms) of 2 to 36 or 60 carbon atoms and more preferably 2 or 4 to 12 carbon atoms and R_{c} and R_{d} are individually a linear or branched alkyl group of 1 to 8 carbon atoms, more preferably 1 or 2 to 4 carbon atoms or R_{c} and R_{d} connect together to form a single linear or branched alkylene group of 1 to 8 carbon atoms or optionally with one of R_{c} and R_{d} is connected to R_{b} at a carbon atom, more desirably R_{c} and R_{d} being an alkyl group of 1 or 2 to 4 carbon atoms.

In one embodiment, desirably at least 50 wt. %, or at least 60, 70, 80 or 90 wt. % of said polyamide oligomer or telechelic polyamide comprise repeat units from lactams or amino carboxylic acids of the structure:

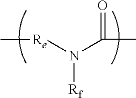

Repeat units can be in a variety of orientations in the oligomer derived from lactams or amino carboxylic acid depending on initiator type, wherein each Rₑ independently is linear or branched alkylene of 4 to 12 carbon atoms and each R_{f} independently is a linear or branched alkyl of 1 to 8, more desirably 1 or 2 to 4, carbon atoms.

In some embodiments, the telechelic polyamide polyols include those having (i) repeat units derived from polymerizing monomers connected by linkages between the repeat units and functional end groups selected from carboxyl or primary or secondary amine, wherein at least 70 mole percent of telechelic polyamide have exactly two functional end groups of the same functional type selected from the group consisting of amino or carboxylic end groups; (ii) a polyamide segment comprising at least two amide linkages characterized as being derived from reacting an amine with a carboxyl group, and said polyamide segment comprising repeat units derived from polymerizing two or more of monomers selected from lactams, aminocarboxylic acids, dicarboxylic acids, and diamines; (iii) wherein at least 10 percent of the total number of the heteroatom containing linkages connecting hydrocarbon type linkages are characterized as being amide linkages; and (iv) wherein at least 25 percent of the amide linkages are characterized as being tertiary amide linkages.

The TPU compositions useful in the present invention may, optionally, be made using a chain extender component. Chain extenders include diols, diamines, and combinations thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, dodecanediol, 1,4-cyclohexanedimethanol (CHDM), 2,2-bis[4-(2-hydroxyethoxy) phenyl]propane (HEPP), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof. In some embodiments the chain extender includes BDO, HDO, 3-methyl-1,5-pentanediol, or a combination thereof. In some embodiments, the chain extender includes BDO. Other glycols, such as aromatic glycols could be used, but in some embodiments the TPUs described herein are essentially free of or even completely free of such materials.

To prepare TPU compositions useful in the present invention, the three reactants (the polyol intermediate, the diisocyanate, and the chain extender) may be reacted together. Any known processes to react the three reactants may be used to make the TPU. In one embodiment, the process is a so-called “one-shot” process where all three reactants are added to an extruder reactor and reacted. The equivalent weight amount of the diisocyanate to the total equivalent weight amount of the hydroxyl containing components, that is, the polyol intermediate and the chain extender glycol, can be from about 0.95 to about 1.10, or from about 0.96 to about 1.02, and even from about 0.97 to about 1.005. Reaction temperatures utilizing a urethane catalyst can be from about 175 to about 245° C., and in another embodiment from 180 to 220° C.

In another embodiment, the TPU can also be prepared utilizing a pre-polymer process. In the pre-polymer route, the polyol intermediates are reacted with generally an equivalent excess of one or more diisocyanates to form a pre-polymer solution having free or unreacted diisocyanate therein. The reaction is generally carried out at temperatures of from about 80 to about 220° C., or from about 150 to about 200° C. in the presence of a suitable urethane catalyst. Subsequently, a chain extender, as noted above, is added in an equivalent amount generally equal to the isocyanate end groups as well as to any free or unreacted diisocyanate compounds. The overall equivalent ratio of the total diisocyanate to the total equivalent of the polyol intermediate and the chain extender is thus from about 0.95 to about 1.10, or from about 0.96 to about 1.02 and even from about 0.97 to about 1.05. The chain extension reaction temperature is generally from about 180 to about 250° C. or from about 200 to about 240° C. Typically, the pre-polymer route can be carried out in any conventional device including an extruder. In such embodiments, the polyol intermediates are reacted with an equivalent excess of a diisocyanate in a first portion of the extruder to form a pre-polymer solution and subsequently the chain extender is added at a downstream portion and reacted with the pre-polymer solution. Any conventional extruder can be utilized, including extruders equipped with barrier screws having a length to diameter ratio of at least 20 and in some embodiments at least 25.

In one embodiment, the ingredients are mixed on a single or twin screw extruder with multiple heat zones and multiple feed ports between its feed end and its die end. The ingredients may be added at one or more of the feed ports and the resulting TPU composition that exits the die end of the extruder may be pelletized.

The preparation of the various polyurethanes in accordance with conventional procedures and methods and since as noted above, generally any type of polyurethane can be utilized, the various amounts of specific components thereof, the various reactant ratios, processing temperatures, catalysts in the amount thereof, polymerizing equipment such as the various types of extruders, and the like, are all generally conventional, and well as known to the art and to the literature.

For the present invention, in some embodiments the TPU may be made by reacting the components together in a “one shot” polymerization process wherein all of the components, including reactants are added together simultaneously or substantially simultaneously to a heated extruder and reacted to form the TPU. In other embodiments, the TPU may be made by first reacting the polyisocyanate component with some portion of the polyol component forming a pre-polymer, and then completing the reaction by reacting the pre-polymer with the remaining reactants, resulting in the TPU.

One or more polymerization catalysts may be present during the polymerization reaction. Generally, any conventional catalyst can be utilized to react the diisocyanate with the polyol intermediates or the chain extender. Examples of suitable catalysts which in particular accelerate the reaction between the NCO groups of the diisocyanates and the hydroxy groups of the polyols and chain extenders are the conventional tertiary amines known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, and the like, or bismuth compounds such as bismuth octoate, bismuth laurate, and the like. The amounts usually used of the catalysts are from 0.0001 to 0.1 part by weight per 100 parts by weight of polyhydroxy compound (b).

Various types of optional components can be present during the polymerization reaction, and/or incorporated into the TPU elastomer described above to improve processing and other properties. These additives include but are not limited to antioxidants, such as phenolic types, organic phosphites, phosphines and phosphonites, hindered amines, organic amines, organo sulfur compounds, lactones and hydroxylamine compounds, biocides, fungicides, antimicrobial agents, compatibilizers, electro-dissipative or anti-static additives, fillers and reinforcing agents, such as titanium dioxide, alumina, clay and carbon black, flame retardants, such as phosphates, halogenated materials, and metal salts of alkyl benzenesulfonates, impact modifiers, such as methacrylatebutadiene-styrene (“MBS”) and methylmethacrylate butylacrylate (“MBA”), mold release agents such as waxes, fats and oils, pigments and colorants, plasticizers, polymers, rheology modifiers such as monoamines, polyamide waxes, silicones, and polysiloxanes, slip additives, such as paraffinic waxes, hydrocarbon polyolefins and/or fluorinated polyolefins, and UV stabilizers, which may be of the hindered amine light stabilizers (HALS) and/or UV light absorber (UVA) types. Other additives may be used to enhance the performance of the TPU composition or blended product. All of the additives described above may be used in an effective amount customary for these substances.

These additional additives can be incorporated into the components of, or into the reaction mixture for, the preparation of the TPU resin, or after making the TPU resin. In another process, all the materials can be mixed with the TPU resin and then melted or they can be incorporated directly into the melt of the TPU resin. Additives may be selected by those of ordinary skill in the art based on the desired properties to be imparted to the composite laminate of the present invention.

In one embodiment of the present invention, the TPU composition used to make the TPU film for the composite laminate includes one or more additives selected from antioxidants, biocides, fungicides, antimicrobial agents, compatibilizers, electro-dissipative or anti-static additives, fillers and reinforcing agents, flame retardants, impact modifiers, mold release agents such as waxes, fats and oils, pigments and colorants, plasticizers, polymers, rheology modifiers, slip additives, and UV stabilizers. In one particular embodiment, the TPU composition of the present invention includes UV stabilizers, in particular, one or more of hindered amine light stabilizers (HALS) and/or UV light absorber (UVA) types.

### Thermoplastic Polyurethane Films

The compositions of the invention and any blends thereof may be formed into monolayer or multilayer films. These films may be formed by any of the conventional techniques known in the art including extrusion, co-extrusion, extrusion coating, lamination, blowing, thermoforming, and casting or any combination thereof. The film may be obtained by the flat film or tubular process which may be followed by orientation in an uniaxial direction or in two mutually perpendicular directions in the plane of the film. One or more of the layers of the film may be oriented in the transverse and/or longitudinal directions to the same or different extents. This orientation may occur before or after the individual layers are brought together. Typically, the films are oriented in the Machine Direction (MD) at a ratio of up to 15, preferably between 5 and 7, and in the Transverse Direction (TD) at a ratio of up to 15 preferably 7 to 9. However in another embodiment, the film is oriented to the same extent in both the MD and TD directions.

Films useful in the present invention may vary in thickness, for example, a thickness from 1 μm to 5000 μm, for example, 1 μm to 4000 μm, 1 μm to 3000 μm, 1 μm to 2000 μm, or even 1 μm to 1000 μm may be suitable.

In another embodiment, one more layers may be modified by corona treatment, electron beam irradiation, gamma irradiation, or microwave irradiation. In a preferred embodiment, one or both of the surface layers is modified by corona treatment.

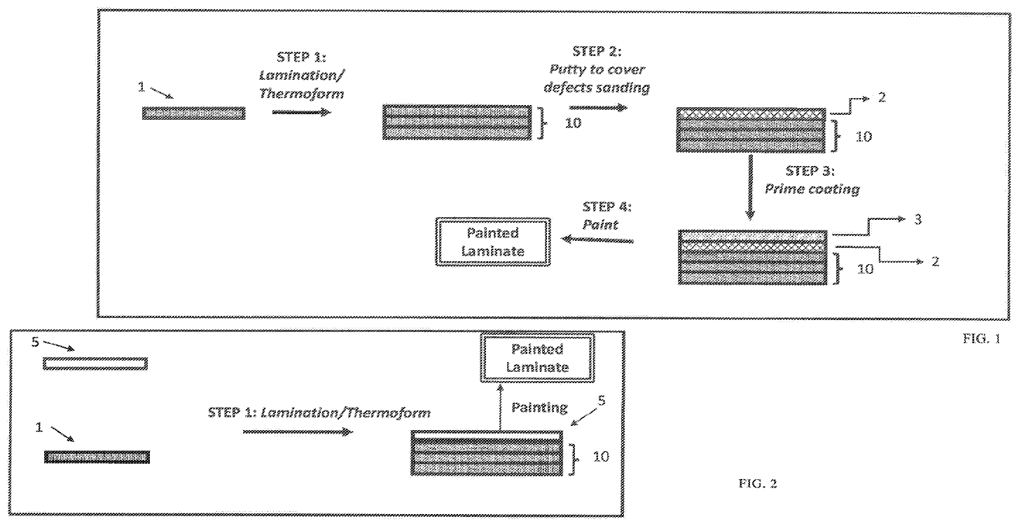

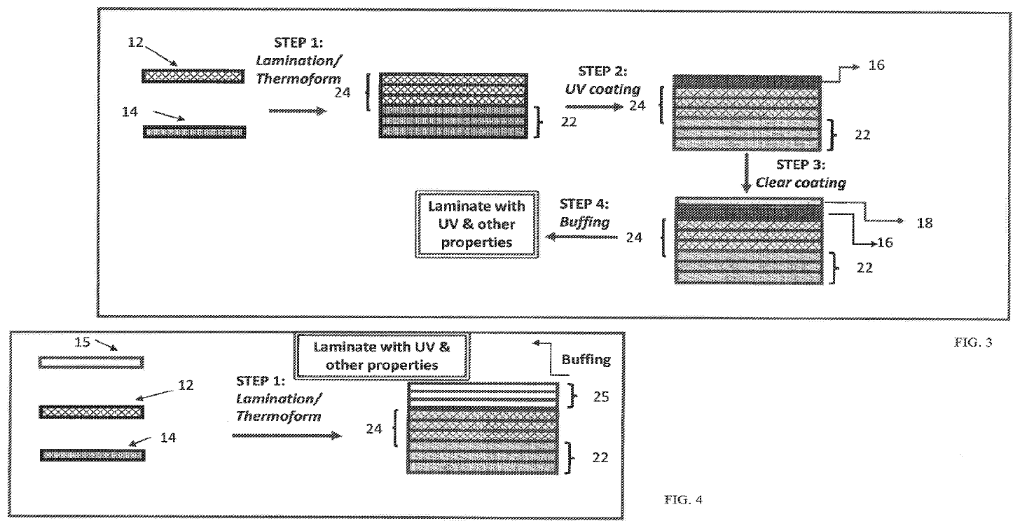

Turning now to the drawings, FIG. 1 and FIG. 3 illustrate prior art processes for preparing composite laminate structures. In FIG. 1 layers of a prepreg containing unidirectionally arranged fibers 1 are used to form a laminate structure 10. The laminate structure 10 may include anywhere from 1 to 10, for example 1 to 6, layers or unidirectional fiber prepreg. The surface 11 of the laminate structure 10 typically will contain surface defects that require the application of fillers, such as putty, and subsequent sanding in order to provide a surface that may be painted. Putty is applied to the top layer and the putty layer is sanded 2 to create a paint-ready surface. A primer layer 3 is applied over the sanded putty layer 2 and then a top coat of paint is applied to provide the desired decorative effect resulting in a complete carbon laminate structure. FIG. 3 illustrates a second prior art process, which uses at least one prepreg having unidirectional fibers 14 and a prepreg having woven fibers 12. These prepeg layers are laminated together, for example a laminate may include 1 to 10, for example, 1 to 6 layers of prepreg having unidirectional fibers and 1 to 10, for example, 1 to 6 layers of prepreg having woven fibers. In the example illustrated in FIG. 3, a UV coating 16 and then a clear coat 18 are applied to the laminate. The coating layers may require additional processing such as buffing to provide the final useful composite laminate structure.

FIG. 2 illustrates a process for making a composite laminate structure in accordance with one embodiment of the present invention. In this embodiment, layers of prepreg containing unidirectionally arranged fibers 1 and a thermoplastic polyurethane (TPU) film 5 are provided. The TPU film 5 may be clear or pigmented. The composite structure may include 1 to 10, for example, 1 to 6, layers of a prepreg containing unidirectionally arranged fibers. In one embodiment, where multiple layers of prepregs containing unidrectionally arranged fibers are used, each layer of prepreg may be positioned such that the fibers of one layer are perpendicular to the fibers in adjacent layers. Heat and or pressure, such as by thermoforming or lamination processes are applied to the prepreg layers and the TPU film to form the composite laminate structure. No additional binders are required other than the resin of the prepreg layers and the TPU film. The TPU film 5 on the surface of this laminate structure is ready to be painted directly without further processing to result in a final useful composite laminate structure.

FIG. 4 illustrates a process for making a composite laminate structure in accordance with another embodiment of the present invention. In this embodiment, layers of prepreg containing unidirectionally arranged fibers 14, layers of prepreg containing woven fibers 12, and a thermoplastic polyurethane (TPU) film 15 are provided. The TPU film 15 may be clear or pigmented. Heat and/or pressure are applied, such as by thermoforming or lamination processes to adhrere the layers together. No additional binders are required other than the resin in the prepreg layers and the TPU film.

In the laminates described herein, for example, those illustrated in the drawings, the TPU film layer may comprise two layers of TPU film. In such an embodiment, the TPU film layer may comprise a first relatively softer layer and a second relatively harder layer. For example, the first layer may have a hardness from about 55 Shore A to 95 Shore A, for example, 55 Shore A to 90 Shore A, while the second layer has a hardness from about 95 Shore A to 85 Shore D, for example, 95 Shore A to 60 Shore D. In one embodiment, the first layer may have a thickness from about 1 μm to about 250 μm, for example, 1 μm to about 100 μm, while the second layer has a thickness of about 100 μm to about 5000 μm, for example, about 100 μm to about 4000 μm, or even about 100 μm to about 3000 μm, or even about 250 μm to about 2500 μm, or even about 500 μm to about 1000 μm. The two layers may be co-extruded with the bottom layer (to be positioned adjacent to the prepreg) being the relatively softer, thinner layer and the top (surface) layer being the relatively harder, thicker layer.

In one embodiment of the composite laminate illustrated in FIG. 2, the TPU may comprise a TPU composition comprising an aromatic polyisocyanate and having a hardness of 60 Shore D or above. This aromatic TPU composition would be the top (surface) layer in a two layer TPU film as described above. This aromatic TPU composition may be clear or pigmented.

In one embodiment of the composite laminate illustrated in FIG. 4, the TPU may comprise a TPU composition comprising a polycaprolactone polyol having a hardness of 80 Shore A to 85 Shore D, for example, 60 Shore D to 80 Shore D. This polycaprolactone based thermoplastic polyurethane composition would be the top layer in a two layer TPU film as described above. The polycaprolactone TPU composition may be clear or pigmented.

Pigmented or colored TPU compositions used as a surface layer in the present invention may be colored by known methods, including by adding pigments directly to the TPU composition or by use of pigmented TPU masterbatches which may be added to the TPU composition without affecting the other beneficial properties of the TPU.

The TPU compositions used to make the films for the embodiments illustrated in FIGS. 2 and 4 can be formulated to provide a variety of beneficial properties to the composite laminate, such as resistance to water, solvents, UV light, weather, abrasion, corrosion, as well as any other useful properties known in the art. In one embodiment, the TPU compositions used in the composite laminate of the present invention are transparent or substantially transparent. In other embodiments, the TPU films may have pigments or colors added to provide a decorative surface to the laminate. These properties are available from the TPU layer directly without the need for additional processing of the composite laminate structure and the application of additional coating layers.

To make the composite laminates of the present invention, the desired number of layers of prepreg are stacked and a TPU film is positioned on the top surface of the stack of prepreg layers. The arranged laminate materials are placed in to a vessel, such as an autoclave or thermoform press and the temperature is set to ramp up from about 100° F. to about 350° F., for example 200° F. to 325° F. In some embodiments, the process may take an hour or more to complete, but other processes may provide a finished composite laminate product in minutes. The composite laminates of the present invention may be formed into a mold, or may be formed as flat sheets of laminate which are then cut for particular applications.

Composite laminate structures made in accordance with the present invention can find use in a wide array of applications. The applications include any uses of composite laminate structures currently known or developed in the future in a variety of industries, including but not limited to aerospace applications, for example, fuselage, engines, as well as interior and exterior parts; energy applications, for example, wind turbine blades and stands; automotive applications, for example, engine-hoods, roofs, bumpers, mirrors, dash-boards, interior panels, as well as exterior and interior parts; vessels exposed to high pressure, for example, tanks and airline fuselage; concrete structure applications, for example, pillar re-enforcement; sports and recreation applications, for example, shoe soles, protective equipment, ski equipment, bicycle frames, safety equipment, such as helmets or pads; all-terrain vehicles; marine applications, such as boats, or jet-skis; electronic applications; among other applications.

1. A composite laminate article comprising:
(a) one or more prepreg sheet layers, wherein the prepreg sheet layer comprises fibers impregnated with a resin; and
(b) a thermoplastic polyurethane film layer,
wherein the prepreg layer and and thermoplastic polyurethane film layer are bonded together without the use of a separate binder component.

2. The article of claim 1, wherein the thermoplastic polyurethane film is made from a thermoplastic polyurethane composition comprising the reaction product of a polyol component, a polyisocyanate component, and, optionally, a chain extender component.

3. The article of claim 1, wherein the polyol component comprises a polyester polyol.

4. The article of claim 3, wherein the polyester polyol component comprises a polycaprolactone polyester polyol.

5. The article of claim 1, wherein the polyol component comprises polycarbonate polyol.

6. The article of claim 1, wherein the polyol component comprises polyether polyol.

7. The article of claim 1, wherein the polyol component comprises a polysiloxane polyol.

8. The article of claim 1, wherein polyol component comprises a telechelic polyamide polyol.

9. The article of claim 1, wherein the polyisocyanate comprises an aromatic diisocyanate.

10. The article of claim 9, wherein the aromatic diisocyanate comprises 4,4′-methylenebis(phenyl isocyanate).

11. The article of claim 1, wherein the polyisocyanate comprises an aliphatic diisocyanate.

12. The article of claim 11, wherein the aliphatic diisocyanate comprises H₁₂MDI, HDI, or mixtures thereof.

13. The article of claim 1, wherein the thermoplastic polyurethane film layer contains one or more additives selected from the group consisting of antioxidants, biocides, fungicides, antimicrobial agents, compatibilizers, electro-dissipative or anti-static additives, fillers and reinforcing agents, flame retardants, impact modifiers, mold release agents such as waxes, fats and oils, pigments and colorants, plasticizers, polymers, rheology modifiers, slip additives, and UV stabilizers.

14. The article of claim 1, wherein the fibers are fibers made from a material selected from the group consisting of carbon, graphite, glass, minerals, or polymers.

15. The article of claim 1, wherein the fibers are carbon fibers.

16. The article of claim 15, wherein the prepreg sheet contains unidirectional carbon fibers.

17. The article of claim 15 wherein the prepreg sheet contains woven carbon fibers.

18. The article of claim 1, wherein the composite laminate article comprises a first prepreg sheet containing unidirectional carbon fibers and a second prepreg sheet containing woven carbon fibers.

19. The article of claim 1, wherein the resin of the prepreg sheet is selected from epoxy, phenolic, bismaleimide, polyimide, cyanate ester, polycarbonate, polyester, polystyrene, polyether, styrene, acrylonitrile, butadiene, acrylate, methacrylate, polyacetal, polysulfone, polyurethane, thermoplastic polyurethane and mixtures thereof.

20. The article of claim 17 wherein the resin is a thermoset epoxy resin.

21. A laminate article comprising:
a unidirectional fiber prepreg;
a woven fiber prepreg; and
a thermoplastic polyurethane film, wherein the thermoplastic polyurethane film is an extruded film comprising the reaction product of a polyol component, an isocyanate component, and, optionally, a chain extender component,
wherein the thermoplastic polyurethane film is adhered to the unidirectional fiber prepreg or the woven fiber prepreg without the use of a separate binders.

22. The laminate article of claim 21 wherein the unidirectional fiber prepreg and the woven fiber prepreg comprise carbon fibers.

23. The laminate article of claim 21, wherein the unidirectional fiber prepreg and woven fiber prepreg comprise epoxy resin.

24. The laminate article of claim 21, wherein the thermoplastic polyurethane film comprises a two layer thermoplastic polyurethane film, comprising a bottom thermoplastic polyurethane layer having a hardness of 55 A to 95 A and a top thermoplastic polyurethane layer having a hardness of 95 A to 85 DD.

25. The laminate article of claim 24 wherein the top thermoplastic polyurethane layer comprises a polycaprolactone polyol.

26. The laminate article of claim 24 wherein the bottom thermoplastic polyurethane layer has a film thickness of 1 μm to 250 μm and the top thermoplastic polyurethane layer has a film thickness of 250 μm to 5000 μm.

27. A laminate article comprising:
a first unidirectional fiber prepreg;
a second unidirectional fiber prepreg; wherein the first unidirectional fiber prepreg and the second unidirectional fiber prepreg are positioned adjacent to each other such that the fibers of the first unidirectional fiber prepreg are perpendicular to the fibers of the second unidirectional fiber prepreg;
a two layer thermoplastic polyurethane film, comprising a bottom thermoplastic polyurethane layer having a hardness of 55 A to 95 A and a top thermoplastic polyurethane layer having a hardness of 95 A to 85 D.

28. The laminate article of claim 27 wherein the bottom thermoplastic polyurethane layer has a film thickness of 1 μm to 250 μm and the top thermoplastic polyurethane layer has a film thickness of 250 μm to 5000 μm.

29. The laminate article of claim 27, wherein the top thermoplastic polyurethane layer comprises an aromatic polyisocyanate.

30. A method of making a composite laminate structure comprising:
providing an extruded film, wherein the film comprises a thermoplastic polyurethane composition comprising the reaction product of a polyol component, an isocyanate component, and optionally, a chain extender component;
providing at least one prepreg sheet;
stacking the extruded film and at least one prepreg sheet; and
applying heat to bond the extruded film and prepreg sheet together.

31. The method of claim 30, wherein the step of providing at least one prepreg sheet comprises:
providing one or more unidirectional fiber prepregs.

32. The method of claim 30, wherein the step of providing at least one prepreg sheet comprises:
providing one or more woven fiber prepregs.

33. The method of claim 30, wherein the step of providing an extruded film comprises:
providing a two layer extruded film, wherein the two layer extruded film comprises a layer having a hardness of 55 A to 95 A and a top layer having a hardness of 95 A to 85 D.

34. The method of claim 33, wherein the bottom layer has a film thickness of 1 μm to 250 μm and the top layer has a film thickness of 250 μm to 5000 μm.

35. The method of claim 30, further comprising:
placing the stacked extruded film and at least one prepreg sheet in a mold and autoclave.
